(19) United States
(12) Patent Application Publication
(10) Pub. No.: US 2008/0046509 A1
(43) Pub. Date: Feb. 21, 2008

(54) Peer to peer distribution system and method

(75) Inventors: Edward K.Y. Jung, Bellevue, WA (US); Royce A. Levien, Lexington, MA (US); Robert W. Lord, Seattle, WA (US); Mark A. Malamud, Seattle, WA (US); John D. Rinaldo JR., Bellevue, WA (US)

Correspondence Address: Searete LLC, Suite 110, 1756 - 114th Ave. S.E., Bellevue, WA, 98004, US

(73) Assignee: Searete LLC, a limited liability corporation of the State of Delaware

(21) Appl. No.: 11/893,369

(22) Filed: Aug. 14, 2007

Related U.S. Application Data
(63) Continuation-in-part of application No. 11/881,728, filed on Jul. 26, 2007.
(63) Continuation-in-part of application No. 11/440,713, filed on May 24, 2006.

(51) Int. Cl. G06F 15/16

(52) U.S. Cl. 709/203

(57) ABSTRACT

Methods and related systems relating to peer to peer content distribution.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)).

### RELATED APPLICATIONS

For purposes of the USPTO extra-statutory requirements, the present application constitutes a continuation-in-part of U.S. patent application Ser. No. 11/440,713, entitled CONTENT DISTRIBUTION SERVICE, naming Edward K. Y. Jung; Royce A. Levien; Robert W. Lord; Mark A. Malamud; John D. Rinaldo, Jr. as inventors, filed 24 May 2006, which is currently co-pending, or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003, available at http://www.uspto.gov/web/offices/com/sol/og/2003/week11/patbene.htm. The present Applicant Entity (hereinafter “Applicant”) has provided above a specific reference to the application(s) from which priority) is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### SUMMARY

An embodiment provides a method. In one implementation, a method includes but is not limited to transmitting information indicating content to at least one remote user, receiving a request for a specific instance of said content from said at least one remote user, transmitting at least a portion of said specific instance of said content to said at least one remote user, recording information indicating that said at least a portion of said specific instance of said content was transmitted to said at least one remote user, and receiving data indicative of a credit transfer for transmitting said at least a portion of said specific instance of said content to said at least one remote user. In addition to the foregoing, other method aspects are described in the claims, drawings, and text forming a part of the present disclosure.

An embodiment provides a system. In one implementation, a system includes but is not limited to circuitry for transmitting information indicating content to at least one remote user, circuitry for receiving a request for a specific instance of said content from said at least one remote user, circuitry for transmitting at least a portion of said specific instance of said content to said at least one remote user, circuitry for recording information indicating that said at least a portion of said specific instance of said content was transmitted to said at least one remote user, and circuitry for receiving data indicative of a credit transfer for transmitting said at least a portion of said specific instance of said content to said at least one remote user. In addition to the foregoing, other system aspects are described in the claims, drawings, and text forming a part of the present disclosure.

An embodiment provides a method. In one implementation, a method includes but is not limited to receiving information indicating content from at least one remote user, transmitting a request for a specific instance of said content to said at least one remote user, receiving at least a portion of said specific instance of said content from said at least one remote user, recording information indicating that said at least a portion of said specific instance of said content was received from said at least one remote user, and transmitting data indicative of a credit transfer for said at least a portion of said specific instance of said content. In addition to the foregoing, other method aspects are described in the claims, drawings, and text forming a part of the present disclosure.

An embodiment provides a system. In one implementation, a system includes but is not limited to circuitry for receiving information indicating content from at least one remote user, circuitry for transmitting a request for a specific instance of said content to said at least one remote user, circuitry for receiving at least a portion of said specific instance of said content from said at least one remote user, circuitry for recording information indicating that said at least a portion of said specific instance of said content was received from said at least one remote user, and circuitry for transmitting data indicative of a credit transfer for said at least a portion of said specific instance of said content. In addition to the foregoing, other system aspects are described in the claims, drawings, and text forming a part of the present disclosure.

An embodiment provides a method. In one implementation, a method includes but is not limited to receiving information related to a transmission of at least a portion of a specific instance of content to at least one remote user, recording said information related to said transmission of said at least a portion of said specific instance of said content to said at least one remote user in at least one user account, and transferring credit to said at least one user account for said transmission of said at least a portion of said specific instance of said content to at least one remote user. In addition to the foregoing, other method aspects are described in the claims, drawings, and text forming a part of the present disclosure.

An embodiment provides a system. In one implementation, a system includes but is not limited to circuitry for receiving information related to a transmission of at least a portion of a specific instance of content to at least one remote user, circuitry for recording said information related to said transmission of said at least a portion of said specific instance of said content to said at least one remote user in at least one user account, and circuitry for transferring credit to said at least one user account for said transmission of said at least a portion of said specific instance of said content to at least one remote user. In addition to the foregoing, other system aspects are described in the claims, drawings, and text forming a part of the present disclosure.

An embodiment provides a method. In one implementation, a method includes but is not limited to transmitting at least a portion of a specific instance of content to at least one remote user, and receiving data indicative of a credit transfer for transmitting said at least a portion of said specific instance of said content to said at least one remote user. In addition to the foregoing, other method aspects are described in the claims, drawings, and text forming a part of the present disclosure.

An embodiment provides a system. In one implementation, a system includes but is not limited to circuitry for transmitting at least a portion of a specific instance of content to at least one remote user, and circuitry for receiving data indicative of a credit transfer for transmitting said at least a portion of said specific instance of said content to said at least one remote user. In addition to the foregoing, other system aspects are described in the claims, drawings, and text forming a part of the present disclosure.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer. In addition to the foregoing, other system aspects are described in the claims, drawings, and text forming a part of the present application.

An embodiment provides a method. In one implementation, a method includes but is not limited to receiving at least a portion of said specific instance of said content from said at least one remote user, and transmitting data indicative of a credit transfer for said at least a portion of said specific instance of said content. In addition to the foregoing, other method aspects are described in the claims, drawings, and text forming a part of the present disclosure.

An embodiment provides a system. In one implementation, a system includes but is not limited to circuitry for receiving at least a portion of said specific instance of said content from said at least one remote user, and circuitry for transmitting data indicative of a credit transfer for said at least a portion of said specific instance of said content. In addition to the foregoing, other method aspects are described in the claims, drawings, and text forming a part of the present disclosure.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer. In addition to the foregoing, other system aspects are described in the claims, drawings, and text forming a part of the present application.

### BRIEF DESCRIPTION OF THE FIGURES

FIG. 1 illustrates an example peer to peer distribution system in which an embodiment may be implemented.

FIG. 2 illustrates an operational flow representing example operations related to techniques for peer to peer content distribution.

FIG. 3 illustrates an alternative embodiment of the example operational flow of FIG. 2.

FIG. 4 illustrates an alternative embodiment of the example operational flow of FIG. 2.

FIG. 5 illustrates an alternative embodiment of the example operational flow of FIG. 2.

FIG. 6 illustrates an alternative embodiment of the example operational flow of FIG. 2.

FIG. 7 illustrates an alternative embodiment of the example operational flow of FIG. 2.

FIG. 8 illustrates an alternative embodiment of the example operational flow of FIG. 2.

FIG. 9 illustrates an alternative embodiment of the example operational flow of FIG. 2.

FIG. 10 illustrates an operational flow representing example operations related to techniques for peer to peer content distribution.

FIG. 11 illustrates an alternative embodiment of the example operational flow of FIG. 10.

FIG. 12 illustrates an alternative embodiment of the example operational flow of FIG. 10.

FIG. 13 illustrates an alternative embodiment of the example operational flow of FIG. 10.

FIG. 14 illustrates an alternative embodiment of the example operational flow of FIG. 10.

FIG. 15 illustrates an alternative embodiment of the example operational flow of FIG. 10.

FIG. 16 illustrates an alternative embodiment of the example operational flow of FIG. 10.

FIG. 17 illustrates an alternative embodiment of the example operational flow of FIG. 10.

FIG. 18 illustrates an alternative embodiment of the example operational flow of FIG. 10.

FIG. 19 illustrates an alternative embodiment of the example operational flow of FIG. 10.

FIG. 20 illustrates an operational flow representing example operations related to techniques for peer to peer content distribution.

FIG. 21 illustrates an alternative embodiment of the example operational flow of FIG. 20.

FIG. 22 illustrates an alternative embodiment of the example operational flow of FIG. 20.

FIG. 23 illustrates an alternative embodiment of the example operational flow of FIG. 20.

FIG. 24 illustrates an alternative embodiment of the example operational flow of FIG. 20.

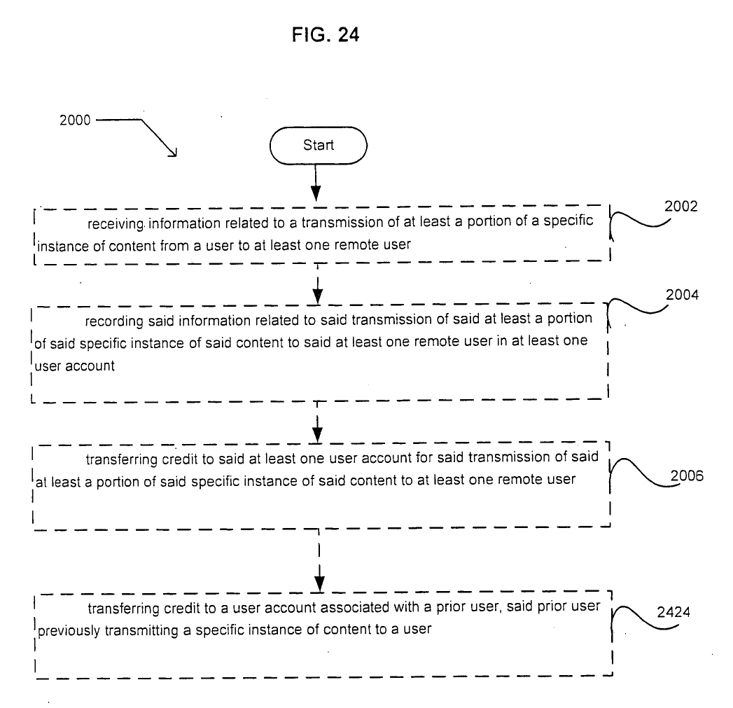

### DETAILED DESCRIPTION

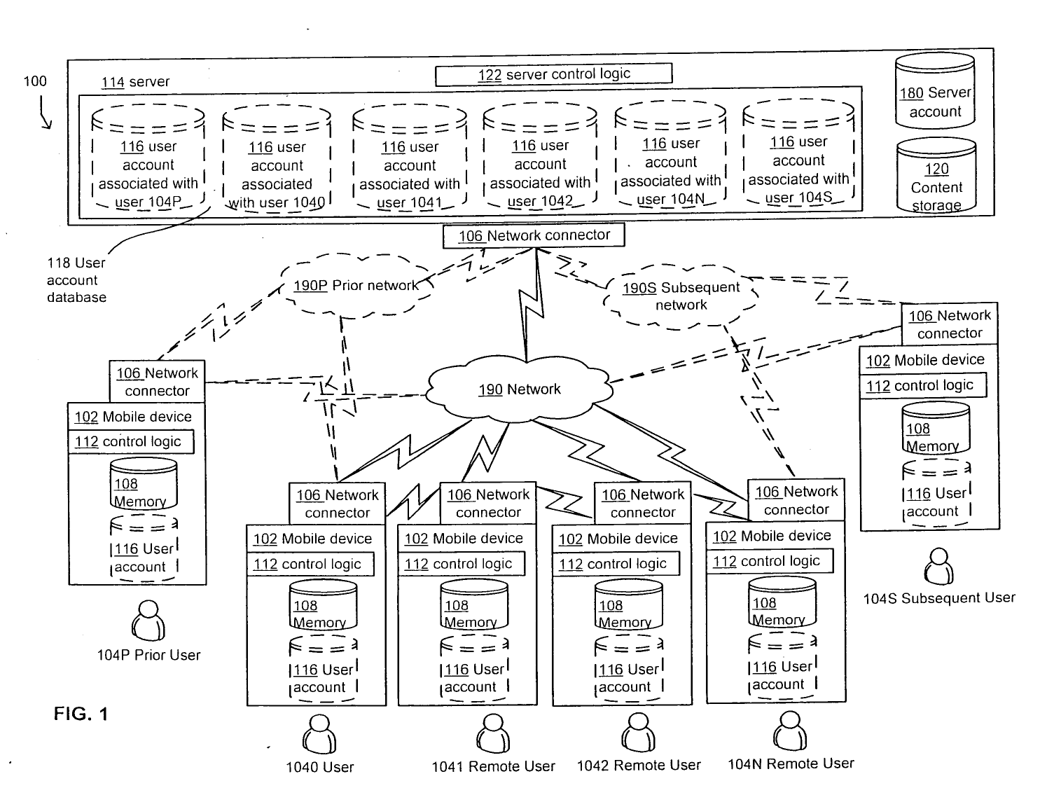

FIG. 1 illustrates an environment 100 in which portions of technologies described herein may be illustrated and/or implemented. FIG. 1 shows environment 100 which may have some or all of the following: server 114; prior network 190P; network 190; subsequent network 190S; prior user 104P having a respectively associated mobile device 102; user 1040, user 1041, . . . , user 104N, with each user shown as having a respectively associated mobile device 102; and subsequent user 104S having a respectively associated mobile device 102. Those skilled in the art will appreciate that in some implementations, various instances of devices (e.g., instances of mobile devices 102 and/or server 114) may communicate directly with each other (e.g., using peer-to-peer schemes), while in other implementations various instances of devices may communicate with and/or through prior network 190P; network 190; and/or subsequent network 190S. Those skilled in the art will further appreciate that although the present description refers mostly to mobile devices for sake of clarity, in some implementations non-mobile devices may also form parts of peer-to-peer network(s).

Server 114 is depicted as having server control logic 122; user account 116 instances of which are shown as respectively associated with each of user 1040, 1041, . . . , 104N; server account 180; and content storage 120. Server 114 is illustrated as having network connector 106 that connects with prior network 190P, network 190, and/or subsequent network 190S.

Each instance of mobile device 102 is shown as having a network connector 106, control logic 112, memory 108, and user account 116. Various instances of mobile device 102 are depicted as having a respective logical association with each of user 1040, 1041, . . . , 1004N. An instance of mobile device 102 is depicted as having a logical association with prior user 104P. An instance of mobile device 102 is depicted as having a logical association with subsequent user 104S. In some implementations, two or more of the devices function as one or more peer-to-peer systems utilizing peer-to-peer network protocols and/or communication schemes. In some implementations, two or more of the devices function as one or more peer-to-peer systems TI provide a system operable to provide on-demand content, such as, for example, movies, TV shows, and/or music to a plurality of buddies (e.g., via methods/systems analogous to those utilized by BitTorrent). In some implementations, one or more instances of device 102 report to server 114 regarding (a) their respectively associated users 1040, 1041, . . . , 104N and (b) transmission/reception of content from/to the one or more instances of device 102. Thereafter server 114 increases/decreases a value of an appropriate instance of user account 116 which is respectively associated with user 1040, 1041, . . . , 104N of the one or more instances of device 102 that are reporting to server 112. For instance, if device 102 associated with user 1040 reported to server 112 a part of the movie Gone With the Wind had been transmitted to mobile device 102 associated with user 1042, server 114 would thereafter cause an increase in value of user account associated user 1040 for such transmission and/or a decrease in value of user account 1042 for such reception, as appropriate to the contractual terms of the business arrangement between the user 1040, 1042, and/or the legal/business entity utilizing server 112. Examples of user 1040, 1042, and/or the legal/business entity utilizing server 112 could entail individuals (e.g., Joe Smith) and/or corporate entities (e.g., Viacom, Sony) Pictures, Universal Studios, Comcast Cable, etc.) and/or government entities (e.g., the State of New York) and/or business partnerships, etc. Other aspects of environment are described in relation to operations/devices described elsewhere herein.

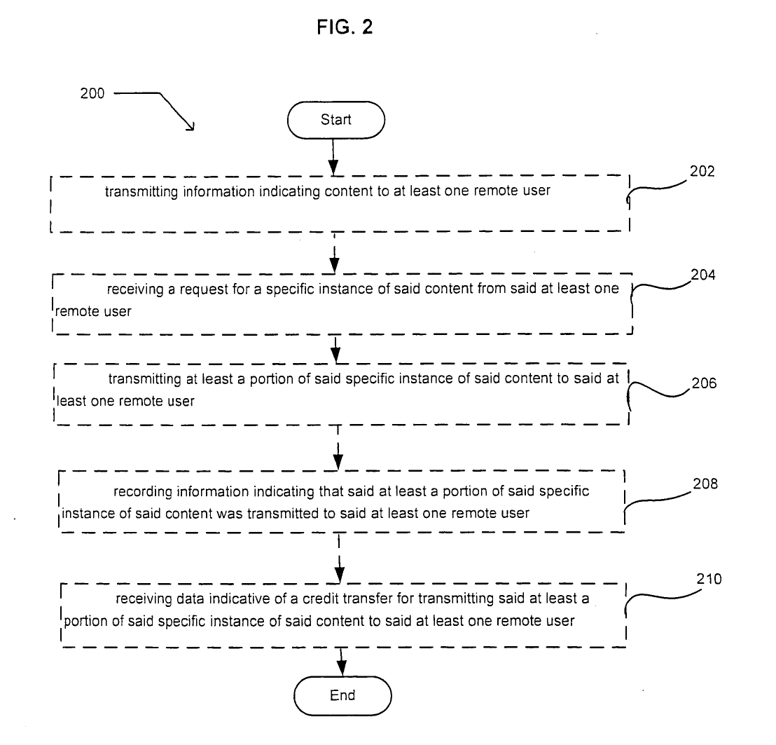

FIG. 2 illustrates the operational flow 200 representing example operations relating to peer to peer content distribution that optionally may include one or more of the operations 202, 204, 206, 208, and/or 210. Those skilled in the art will note that operations 202-210 are indicated by dashed lines, which, in general, is indicative of the fact that such operations are typically to be considered optional, and this is generally true throughout this disclosure with respect to described operations. That is, different implementations will typically employ one or more herein-described operations dependent upon context, and the selection of appropriate operation(s) appropriate to the various context(s) is within the skill of one in the art in light of the teachings herein. Notwithstanding, those skilled in the art will appreciate that, in some contexts, one or more items/operations illustrated in the figures via solid line symbols may also be treated as optional, and that solid lines are typically used herein merely as a courtesy to increase ease-of-reading.

Operation 200 shows the start of the operational process. Operation 202 depicts transmitting information indicating content to at least one remote user. For example, network connector 106 of mobile device 102 transmitting information about the content stored in memory 108 of the mobile device 102 associated with user 1040 to at least one remote user 1041, 1042, . . . , and/or remote user 104N (where N is an integer other than 1) over a network 190. Although the foregoing convention is used throughout for sake of clarity, those skilled in the art will appreciate that in some instances such requests may be transmitted to one or more devices respectively associated with user 1040; and/or remote user 1041; 1042, . . . , and/or 104N; and/or prior user 104P, and/or subsequent user 104S. More specifically, network connector 106 (e.g., an Ethernet connection, one or more 802.11 based networks, and/or a direct connection between two or more devices) of a hand-held device (e.g., cellular phone, PDA, laptop computer, and/or any other mobile device) transmitting a packet containing information about the content stored in the device to at least one buddy. The content may include media (generic elements such as movies, music, ring tones, pictures, and/or videogames) and/or any coupons associated with the media. The content may be stored in, for example, a hard drive, flash memory, and/or EEPROM of the mobile device 102. A specific example of the type of information transmitted may be information indicating the titles of movies, the price of certain videogames, and/or the different types of coupons associated with the media available for purchase.

Operation 204 illustrates receiving a request for a specific instance of said content from said at least one remote user. For example, and in addition to the previous example, network connector 106 of mobile device 102 associated with user 1040 receiving a signal indicative of a request for a specific instance of content (e.g., media such as a specific videogame, movie, song, ring tones, and/or a coupon related to any specific media) stored in memory 108 of mobile device 102 from a remote user 1041, 1042, . . . , and/or remote user 104N. A coupon, for example, may be a promotional code usable by at least one remote user 1041, remote user 1042, . . . , and/or remote user 104N to download a specific instance of media at a reduced price from a server 114, and/or the coupon may be a “key” that may be used to enable a specific instance of media. Additionally, the coupon may be a token, a voucher, a “cookie”, or an installer program that may download a specific occurrence of media when run by a user 1040. The coupon may additionally be stored in memory 108 or generated “on-demand” by control logic 112. A server 114 may be a shared resource, and may include, for example, a content distribution device, one or more telephone switches, one or more analog/digital cable head-ends and/or one or more internet servers. The server may be a combination of hardware, and/or software that is operable to connect with users over a network (e.g., over the internet or other network). More specifically, a wireless adaptor receiving a packet from a buddy. The packet may be indicative of a request to purchase an action videogame stored in the non-volatile memory of a user's hand-held device. Another example may include an Ethernet port receiving a packet from a buddy indicative of a request for a coupon that may be used to download a specific instance of media e.g., game, movie, and/or music album from a content provider and a reduced price.

Operation 206 illustrates transmitting at least a portion of said specific instance of said content to said at least one remote user. For example, and in addition to the previous example, network connector 106 of mobile device 102 associated with user 1040 transmitting at least a portion of a specific occurrence of content stored in memory 108 to at least one remote user 1041, . . . , and/or remote user 104N. More specifically, an example may include a wireless adaptor of a PDA transmitting at least a portion of a specific occurrence of media, e.g., game, movie, music album to a buddy, the portion of the media may be, for example, one or more levels of a multilevel game, a part of a movie, or a part of a music album. The media may be stored in memory of the PDA such as a hard-drive, DRAM, flash RAM, CD-Rom, DVD, flash RAM, and/or a cartridge. Another specific example may include a wireless adaptor of a cellular phone transmitting at least a portion of a coupon to a buddy. The coupon may be used to download a ring tone from a content provider at a reduced price.

Operation 208 illustrates recording information indicating that said at least a portion of said specific instance of said content was transmitted to said at least one remote user. For example, and in addition to the previous example, mobile device 102 recording information in a user account 116 associated with a user 1040 indicating that a user 1040 transmitted at least a part of a specific instance of content to at least one remote user 1041, remote user 1042, . . . , and/or remote user 104N. Although the foregoing convention is used throughout the disclosure for the sake of clarity, those skilled in the art will appreciate that in general a user account 116 may be stored in a mobile device 102, stored in user account database 118 located at a server 114 and accessed via a network connector 106, or a user account 116 may be stored in the mobile device 102 and the server 114. For example, the information in a user account 116 stored in a mobile device 102 may be synchronized with the information and a user account 116 stored at a server 114. More specifically, a hand-held device recording data in an account associated with a user, the data indicating that a user transmitted at least one level of an action game to a buddy.

Operation 210 depicts receiving data indicative of a credit transfer for transmitting said at least a portion of said specific instance of said content to said at least one remote user. For example, and in addition to the previous example, network connector 106 of mobile device 102 receiving a signal from server 114 containing information indicative of a credit transfer (e.g., money transfer, points, and/or any type of value transferred) within user account database 118 to user account 16 associated with user 1040. The credit transfer may be for transmitting at least a part of a specific instance of content to at least one remote user 1041, . . . , and/or remote user 104N. More specifically, a wireless adaptor receiving a packet indicative of a credit transfer to a user's account as compensation for transmitting at least one level of an action game to at least one buddy. Those skilled in the art will appreciate that one or more of the operations/activities described herein may be separated in time as well as geography. For example, in some instances there may be significant relative time lag between operations (e.g., minutes, days, weeks, months, etc.)

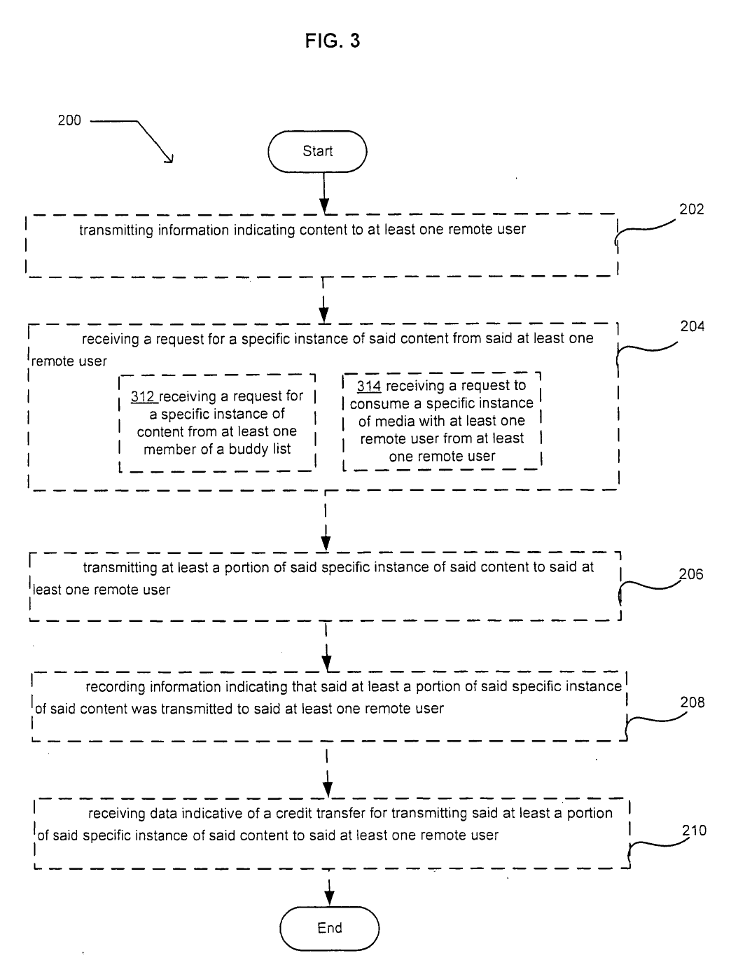

FIG. 3 illustrates an alternative embodiment of the example operational flow 200 of FIG. 2. FIG. 3 illustrates operation 204 receiving a request for a specific instance of said content from said at least one remote user including the operations 312 and 314.

Example operation 312 illustrates receiving a request for a specific instance of content from at least one member of a buddy list. For example, network connector 106 of mobile device 102 receiving a signal indicative of a request for specific occurrence of content, for example, a specific videogame or coupon related to a specific videogame stored in memory 108 from a member of a buddy list stored in a user account 116 associated with a user 1040. More specifically, a wireless adaptor of a hand-held device receiving a packet indicative of a request for an action videogame stored in non-volatile memory. The request coming from a member of a buddy list stored in a user account.

Example operation 314 illustrates receiving a request to consume a specific instance of media with at least one remote user from at least one remote user. For example, network connector 106 of mobile device 102 receiving a signal indicative of a request to consume a specific occurrence of media with at least one remote user 1041, . . . , and/or remote user 104N. More specifically, a wireless adaptor of a hand-held device receiving a packet indicative of a request to consume (e.g., play, watch, hear) a specific instance of media (e.g., videogame, movie, or music track) with at least one buddy.

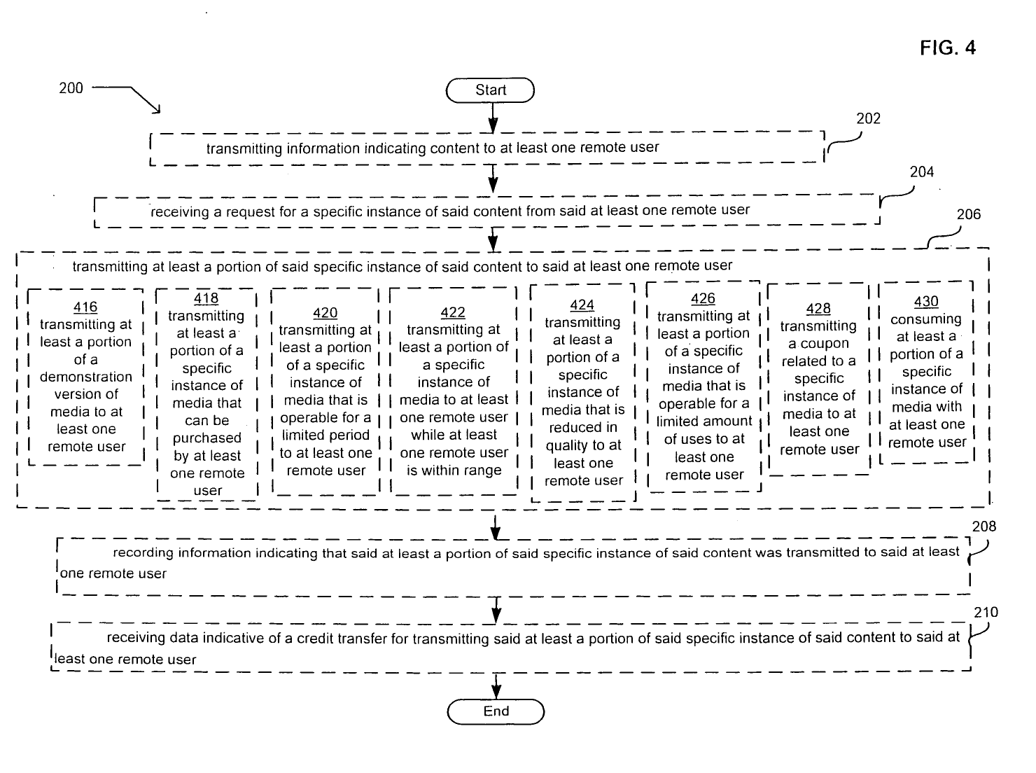

FIG. 4 illustrates alternate embodiments of the example operational flow 200 of FIG. 2. FIG. 4 illustrates the operation 206 transmitting at least a portion of said specific instance of said content to said at least one remote user including the operations 416, 418, 420, 422, 424, 426, 428, and/or 430.

Example operation 416 illustrates transmitting at least a portion of a demonstration version of media to at least one remote user. For example, network connector 106 of mobile device 102 transmitting at least a portion of an occurrence of media that is a promotional version to at least one remote user 1041, . . . , and/or remote user 104N. More specifically, a wireless adaptor of a hand-held device transmitting a packet indicative of a part of a specific videogame that does not have all of the features of a full version to a buddy. E.g., a demo game may only include a small sample of the characters and/or only allow the user to go to a few (virtual) places. A demo version of a movie/music album may only include a select portion of the movie/music album.

Example operation 418 illustrates transmitting at least a portion of a specific instance of media that can be purchased by at least one remote user. For example, network connector 106 of mobile device 102 transmitting at least a portion of a specific videogame to at least one remote user 1041, . . . , and/or remote user 104N that can be purchased. More specifically, a wireless adaptor of a hand-held device transmitting a packet indicative of a part of a version of an action videogame that a buddy can buy.

Example operation 420 illustrates transmitting at least a portion of a specific instance of media that is operable for a limited period to at least one remote user. For example, network connector 106 of mobile device 102 transmitting at least a portion of a specific occurrence of a videogame to at least one remote user 1041, . . . , and/or remote user 104N that will only work for a limited period of time. More specifically, a wireless adaptor of a hand-held device transmitting a packet indicative of a part of an action videogame that their buddy can play for a certain time (e.g., 20 minutes, 1 day, and/or 1 week).

Example operation 422 illustrates transmitting at least a portion of a specific instance of media to at least one remote user while at least one remote user is within range. For example, network connector 106 of mobile device 102 transmitting at least a portion of an occurrence of a videogame while the user 1041, . . . , and/or remote user 104N is within a certain range from the mobile device 102. More specifically, a wireless adaptor of a hand-held device transmitting at least one packet indicative of an action videogame to at least one buddy while the buddy is close to the user (e.g., within 5 meters, within the same building, and/or within the same network).

Example operation 424 illustrates transmitting at least a portion of a specific instance of media that is reduced in quality to at least one remote user. For example, network connector 106 of mobile device 102 transmitting at least a portion of a specific occurrence of a videogame that is different quality than the one user 1040 owns to remote user 1041, . . . , and/or remote user 104N. More specifically, a wireless adaptor of a hand-held device transmitting at least one packet indicative of an action game that is different quality than the one user owns (e.g., transmitting low resolution instead of a high-definition version of a game/movie, and/or transmitting a game/movie at a low quality of service).

Example operation 426 illustrates transmitting at least a portion of a specific instance of media that is operable for a limited amount of uses to at least one remote user. For example, network connector 106 of mobile device 102 transmitting at least a portion of a specific occurrence of a videogame that can only be played a certain number of times to at least one remote user 1041, . . . , and/or remote user 104N. More specifically, a wireless adaptor of a hand-held device transmitting at least one packet indicative of a part of an occurrence of an action game that can only be played a certain number of times to at least one buddy (e.g., buddy can only “die” in the game a certain number of times, buddy can start a game a certain number of times, buddy can join a game a certain number of times, and/or buddy can save their game a certain number of times).

Example operation 428 shows transmitting a coupon related to a specific instance of media to at least one remote user. For example, network connector 106 of mobile device 102 transmitting a signal indicative of a coupon for a specific occurrence of a videogame to at least one remote user 1041, . . . , and/or remote user 104N. The coupon may be used to download, for example, a demo version, a low quality version a discounted version, or any other version of the specific media requested. More specifically, a hand-held device transmitting over a wireless adaptor a packet indicative of a coupon. The coupon may be used to download a 30 second clip of a music video.

Example operation 430 depicts consuming at least a portion of a specific instance of media with at least one remote user. For example, the operation of transmitting a specific occurrence of content may include but is not limited to mobile device 102 transmitting a specific occurrence of media that user 1040 is consuming (e.g., playing, watching, and/or listening) with at least one remote user 1041, and/or remote user 104N. A more specific example may include a person playing at least one level of a transmitted action game with at least one buddy.

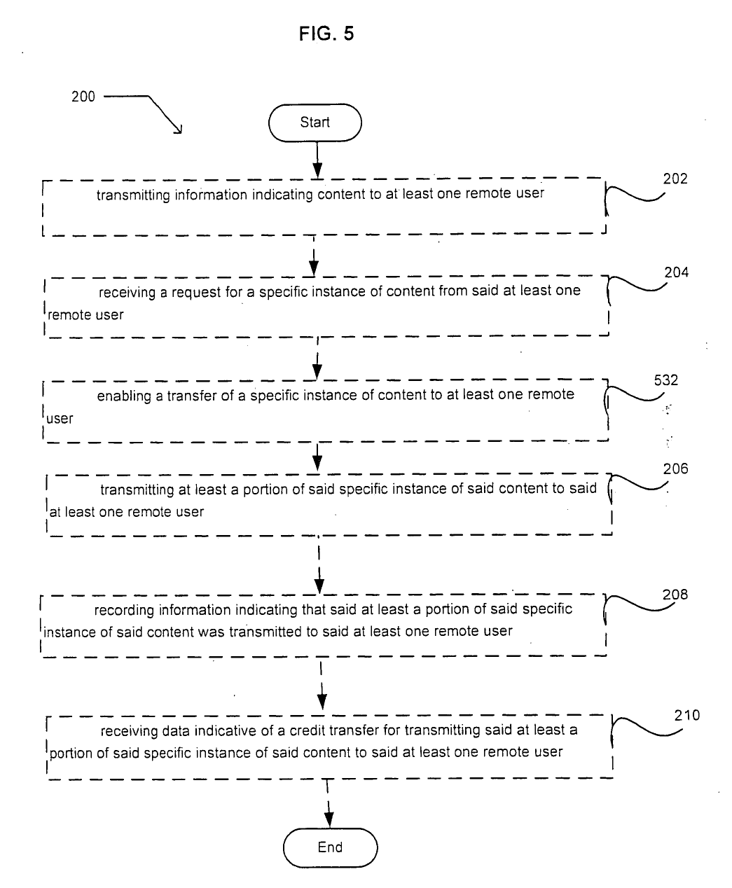

FIG. 5 illustrates an alternative embodiment of the example operational flow 200 of FIG. 2 including the operation 532.

Example operation 532 illustrates enabling a transfer of a specific instance of a content to at least one remote user. For example, control logic 112 of mobile device 102 determining whether user 1040 is permitted to transmit a specific occurrence of content to a remote user 1041, . . . , and/or remote user 104N. More specifically, control logic (e.g., hardware, firmware, and/or software) of a hand-held device running a routine to check whether a user is permitted to transfer a coupon for a specific version of a movie. For example, a program may check for authorization by looking at a permissions list stored in a user account stored in the device, and/or by sending a request for authorization to a content provider.

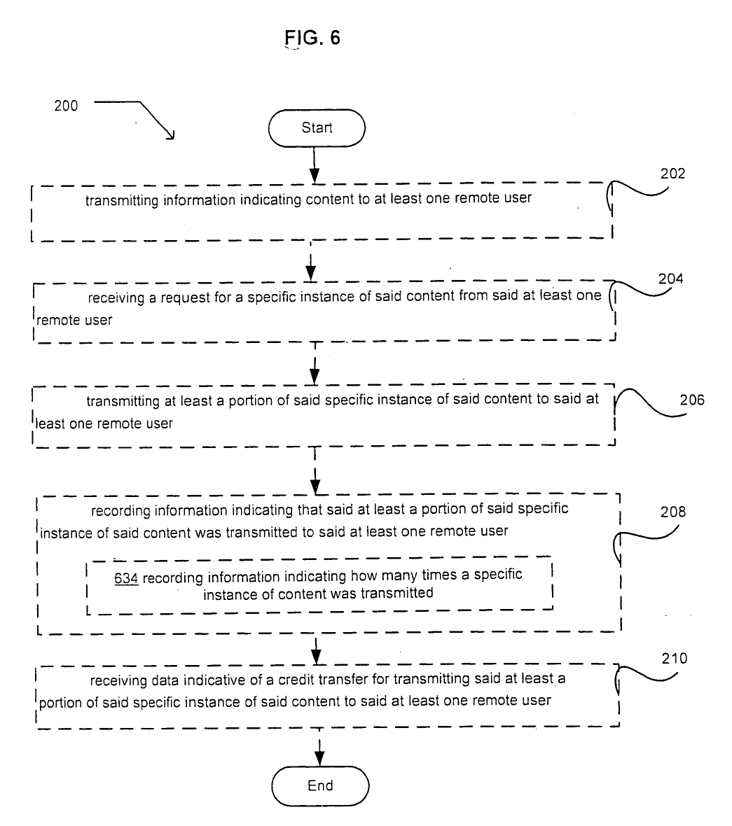

FIG. 6 illustrates an alternative embodiment of the example operational flow 200 of FIG. 2 including the operation 634.

Example operation 634 depicts recording information indicating how many times a specific instance of content was transmitted. For example, control logic 112 of mobile device 102 recording information in a user account 116 associated with a user 1040. The information indicating how many times a user 1040 transmitted a specific instance of content to at least one remote user 1041 . . . , and/or remote user 104N. More specifically, software in a hand-held device logging transactions in a user account. An example transaction may include logging how many times a user transmitted a coupon for a demonstration version of an action videogame to one or more buddies. Those skilled in the art will appreciate that in some instances the information indicating how many times a specific instance of content was transmitted may include one or more of to whom the specific instance of content was transmitted, the time of transmission of the specific instance of content, the way in which the specific instance of content was transmitted (e.g., peer-to-peer, Internet, Intranet, and/or some hybridization thereof), etc.

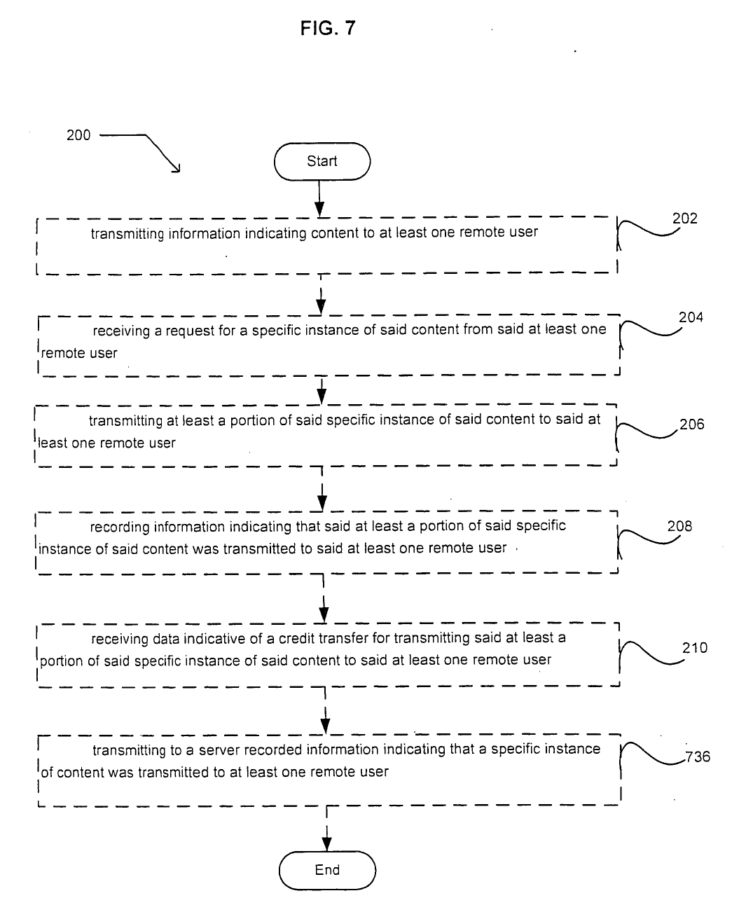

FIG. 7 illustrates an alternative embodiment of the example operational flow 200 of FIG. 2 including the operation 736.

Example operation 736 illustrates transmitting to a server recorded information indicating that a specific instance of content was transmitted to at least one remote user. For example, network connector 106 of mobile device 102 transmitting information indicating that a user transmitted a specific occurrence of content to a remote user 1041, . . . , and/or remote user 104N to a server 114. More specifically a wireless adaptor of a hand-held device transmitted a packet to a multimedia server. The packet containing information indicating that a user transmitted a documentary movie to a buddy. Those skilled in the art will appreciate that in some instances the information indicating how many times a specific instance of content was transmitted may include one or more of to whom the specific instance of content was transmitted, the time of transmission of the specific instance of content, the way in which the specific instance of content was transmitted (e.g., peer-to-peer, Internet, Intranet, and/or some hybridization thereof), etc.

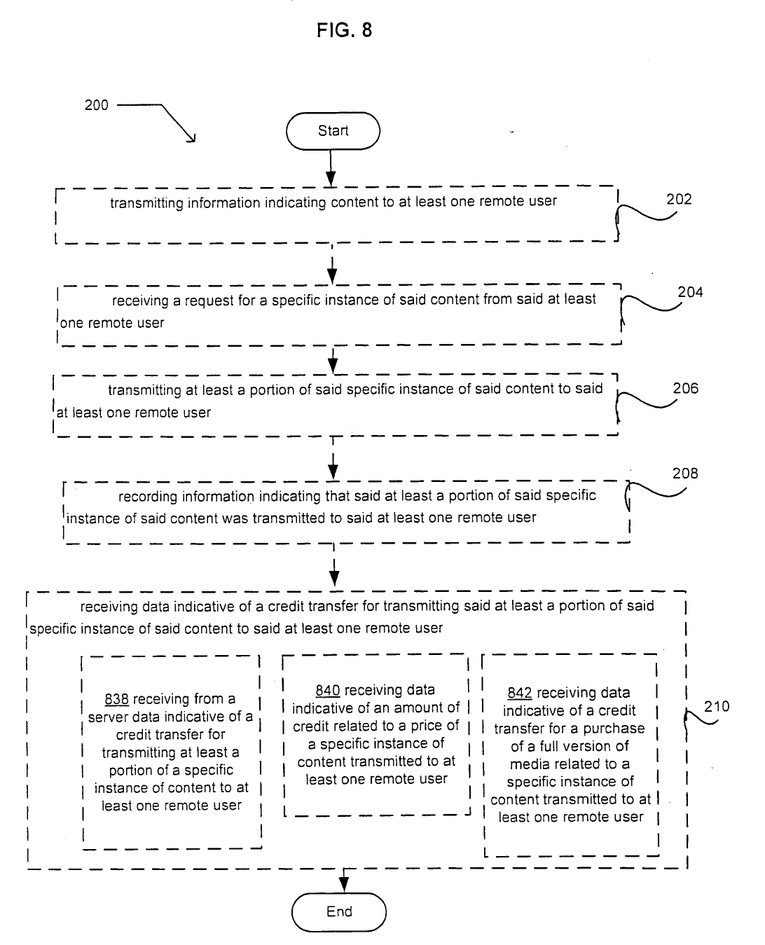

FIG. 8 illustrates an alternative embodiment of the example operational flow 200 of FIG. 2. FIG. 8 illustrates operation 210 receiving data indicative of a credit transfer for transmitting said at least a portion of said specific instance of said content to said at least one remote user including the operations 838, 840, and/or 842.

Example operation 838 depicts receiving from a server data indicative of a credit transfer for transmitting at least a portion of a specific instance of content to at least one remote user. For example, network connector 106 of mobile device 102 receiving a signal from a server 114. The signal indicating that a server 14 transferred credit to a user account 116 associated with a user 1040 for the transmission of at least a part of a specific occurrence of content to at least one remote user 1041, . . . , and/or remote user 104N. More specifically, a wireless adaptor of a hand-held device receiving a packet from a content provider. The packet indicating that the content provider credited the user's account for a transmission of a coupon associated with a specific action videogame to a buddy.

Example operation 840 depicts receiving data indicative of an amount of credit related to a price of a specific instance of content transmitted to at least one remote user. For example, network connector 106 of mobile device 102 receiving a signal. The signal indicating that the user account 116 associated with a user 1040 received an amount of credit related to the value of the specific occurrence of content transmitted to at least one remote user 1041, . . . , and/or remote user 104N. More specifically, a wireless adaptor of a mobile device receiving a packet. The packet indicating that the user received an amount of money proportional to the version of an action videogame transmitted to a buddy (e.g., the user may receive more money for transmitting the entire game than transmitting a demo, or the user may receive more money for transmitting a coupon for a full music video than if they transmitted a version of the music video that only worked for a limited time).

Example operation 842 illustrates receiving data indicative of a credit transfer for a purchase of a full version of media related to a specific instance of content transmitted to at least one remote user. For example, network connector 106 of mobile device 102 receiving a signal. The signal including information indicating that the user account 116 associated with a user 1040 has received credit for a purchase of the entire version of a specific videogame by at least one remote user 1041, . . . , and/or remote user 104N. The purchase coming after the remote user 1041, . . . , and/or remote user 104N had received content related to the specific videogame from a user 1040. More specifically, a hand-held device with a user profile associated with a person receiving a packet containing information indicating that their user account has been credited. The credit is for a buddy's purchase of the full version of the game after the user transferred the demo version to them.

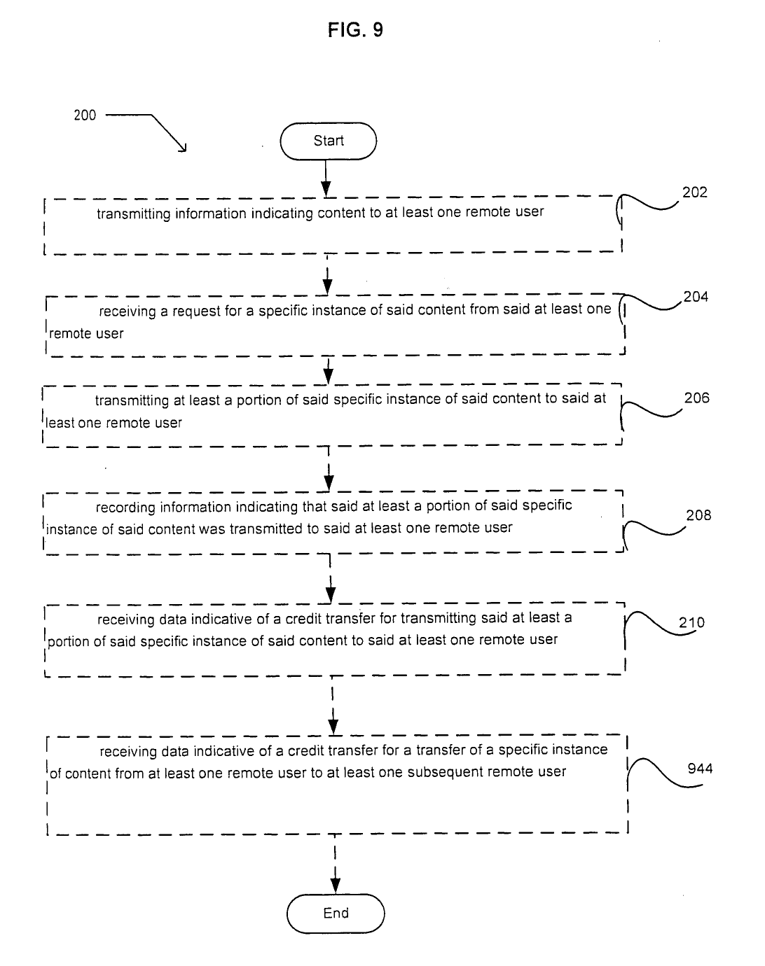

FIG. 9 depicts an alternate embodiment of the example operational flow 200 of FIG. 2 including the operation 944.

Example operation 944 illustrates receiving data indicative of a credit transfer for a transfer of a specific instance of content from at least one remote user to at least one subsequent remote user. For example, network connector 106 of user device 102 receiving information indicative of a transfer of credit to a user account 116 associated with a user 1040. The credit is for the transmission of the specific instance of content from at least one remote user 1041, . . . , and/or remote user 104N to a subsequent user 104S. The subsequent user 104S may be connected to the same network 190 as the user 1040, or the subsequent user 104S may be connected to at least one remote user 1041, . . . , and/or remote user 104N via a subsequent network 190S. More specifically, a wireless adaptor of a hand-held device receiving a packet indicative of a transfer of credit to their account. The user may receive credit for the buddy's subsequent transmission of the coupon for a videogame received from the user to a third party. The buddy may have received the coupon from the user while connected to, for example, a college campus network and subsequently transmitted the coupon to the third party while connected to, for example, a coffee shop's 802.11 network later in the day.

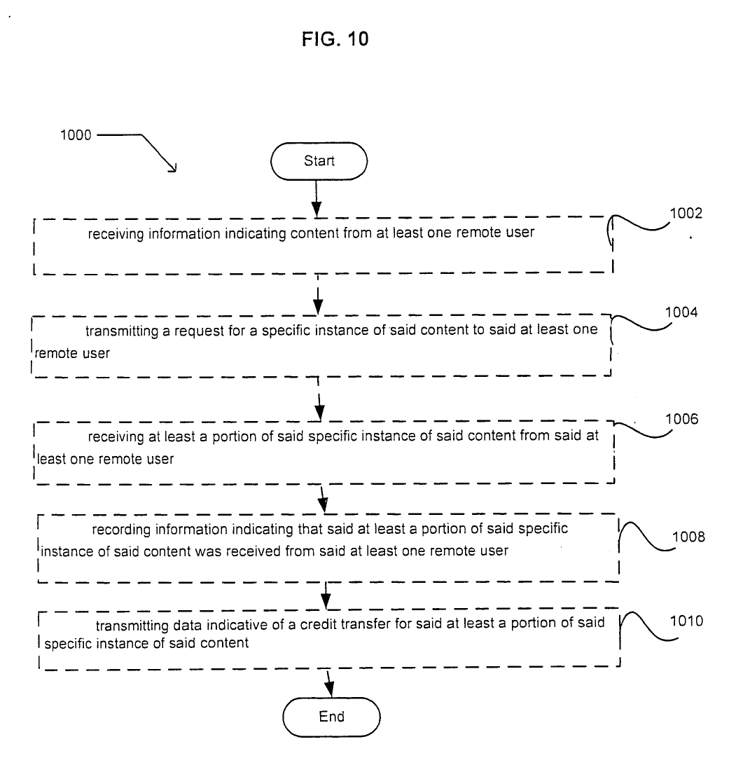

FIG. 10 illustrates the operational flow 1000 representing example operations related to peer to peer content distribution that optionally may include one or more of the operations 1002, 1004, 1006, 1008, and/or 1010.

Operation 1000 begins the operational process. Operation 1002 shows receiving information indicating content from at least one remote user. For example, network connector 106 of mobile device 102 receiving data from at least one remote user 1041, . . . , and/or remote user 104N. The data may be indicative of the content (e.g., the media, and/or coupons associated with media) contained in user devices associated with at least one remote user 1041, . . . , and/or remote user 104N. More specifically, a wireless adaptor of a hand-held device receiving a packet from a buddy, the packet containing information indicating what videogames, movies, songs, or coupons associated with videogames, movies and songs are stored in the device.

Operation 1004 shows transmitting a request for a specific instance of said content to said at least one remote user. For example, and in addition to the previous example, network connector 106 of mobile device 102 transmitting a signal indicative of a request to receive a specific instance of content (e.g., request to have a specific movie streamed, request to download a copy of a specific movie, or receive a coupon for a specific movie) to at least one remote user 1041, . . . , and/or remote user 104N. More specifically, a wireless adaptor of a hand-held device transmitting a packet indicative of a request to download a coupon for a specific movie.

Operation 1006 depicts receiving at least a portion of said specific instance of said content from said at least one remote user. For example, and in addition to the previous example, network connector 106 of mobile device 102 receiving at least a part of a specific instance of content from at least one remote user 1041, . . . , and/or remote user 104N. More specifically, a wireless adaptor of a hand-held device receiving a packet indicative of at least one part of a documentary film from a buddy.

Operation 1008 illustrates recording information indicating that said at least a portion of said specific instance of said content was received from said at least one remote user. For example, and in addition to the previous example, control logic 112 of mobile device 102 storing information in a user account 116 associated with a user 1040. The information indicating that user 1040 received at least a part of a specific occurrence of content from at least one remote user 1041, . . . , and/or remote user 104N. More specifically, software of a hand-held device saving a record in a user account stored in a mobile device 102 or a server 114. The record containing information indicating that the user received at least a portion of a specific documentary movie from a buddy.

Operation 1010 illustrates transmitting data indicative of a credit transfer for said at least a portion of said specific instance of said content. For example, and in addition to the previous example, network connector 106 of mobile device 102 transmitting a signal indicating that the user 1040 transferred credit to at least one remote user 1041, . . . , and/or remote user 104N for at least a portion of a specific occurrence of content. More specifically, a wireless adaptor of a hand-held device transmitting a packet to a buddy for a coupon associated with a specific movie. The packet is indicative of a transfer of credit from the account of the user to the account of their buddy.

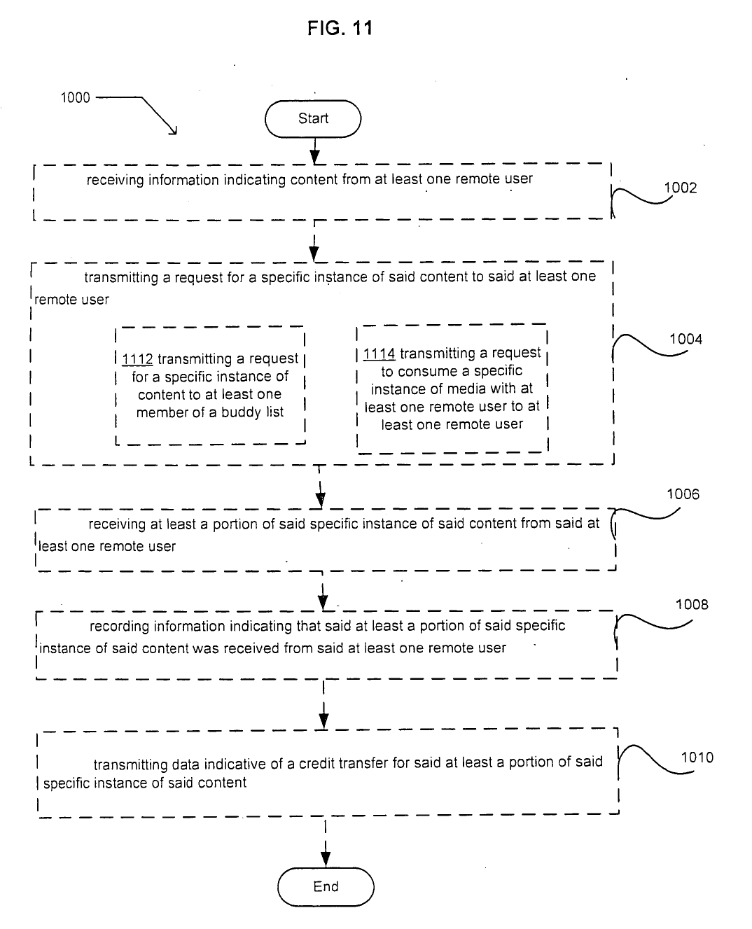

FIG. 11 illustrates an alternative embodiment of the example operational flow 1000 of FIG. 10. FIG. 11 illustrates operation 1004 transmitting a request for a specific instance of said content to said at least one remote user including the operations 1112 and 1114.

Example operation 1112 depicts transmitting a request for a specific instance of content to at least one member of a buddy list. For example, network connector 106 of mobile device 102 transmitting a signal indicative of a request for a specific occurrence of content to at least one member of a buddy list stored in a user account 116 associated with a user 1040. More specifically, a wireless adaptor of a hand-held device transmitting a packet indicative of a request to download a documentary film from a member of a buddy list.

Example operation 1114 depicts transmitting a request to consume a specific instance of media with at least one remote user to at least one remote user. For example, network connector 106 of mobile device 102 transmitting a signal indicative of a request to view a specific occurrence of a movie with at least one remote user 1041, . . . , and/or remote user 104N. More specifically, a wireless adaptor of a hand-held device transmitting a packet indicative of a request to watch an action movie with a buddy.

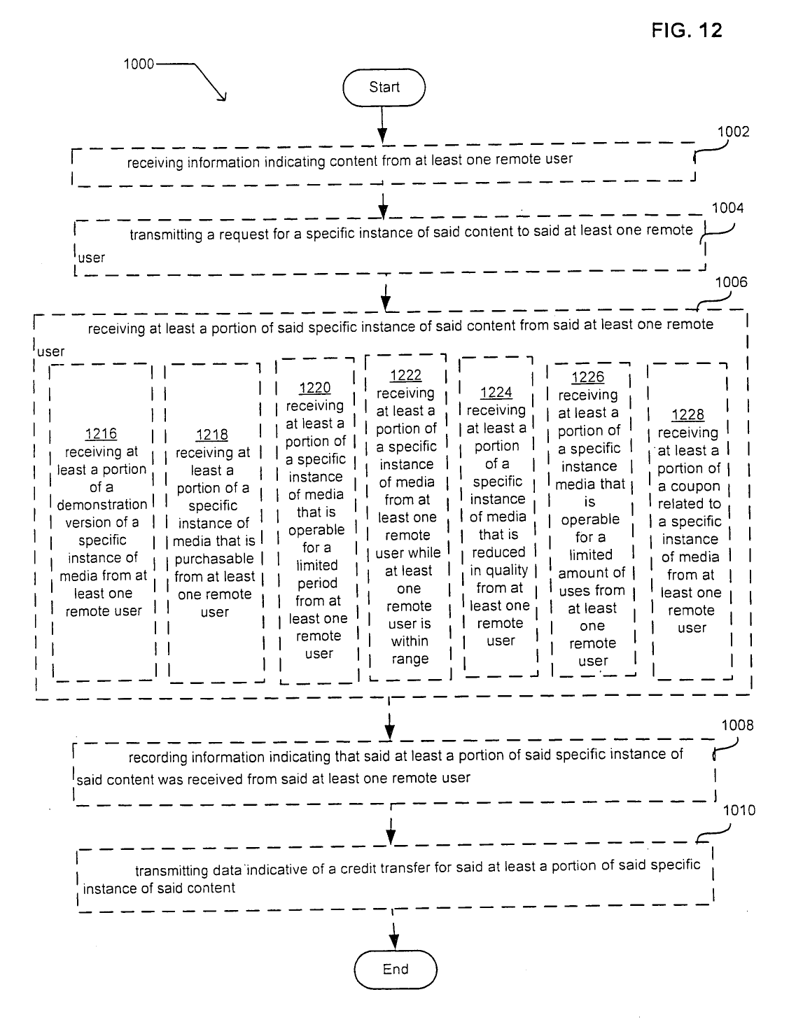

FIG. 12 illustrates an alternative embodiment of the example operational flow 1000 of FIG. 10. FIG. 12 shows operation 1006 receiving at least a portion of said specific instance of said content from said at least one remote user including the operations 1216, 1218, 1220, 1222, 1224, 1226, and/or 1228.

Example operation 1216 shows receiving at least a portion of a demonstration version of a specific instance of media from at least one remote user. For example, network connector 106 of mobile device 102 receiving at least a portion of a sample of a specific instance of a videogame from at least one remote user 1041, . . . , and/or remote user 104N. More specifically, a wireless adaptor of a hand-held device receiving a packet indicative of a part of a videogame that does not have all of the features of the full version from at least one buddy. For example, a demo game may only include a small sample of the characters and/or only allow the user to go to a select few places. A demo version of a movie/music album may only include a select portion of the movie/music album.

Example operation 1218 illustrates receiving at least a portion of a specific instance of media that is purchasable from at least one remote user. For example, network connector 106 of mobile device 102 receiving at least a portion of a specific occurrence of a videogame from at least one remote user 1041, . . . , and/or remote user 104N that can be purchased. More specifically, a wireless adaptor of a hand-held device receiving a packet indicative of a part of an action videogame that a user may buy.

Example operation 1220 illustrates receiving at least a portion of a specific instance of media that is operable for a limited period from at least one remote user. For example, network connector 106 of mobile device 102 receiving at least a portion of a specific instance of a videogame from at least one remote user 1041, . . . , and/or remote user 104N that will only work for a limited period of time. More specifically, a wireless adaptor of a hand-held device receiving a packet indicative of a part of a specific version of an action videogame that can only be played by a user for a certain time (e.g., 20 minutes, 1 day, and/or 1 week).

Example operation 1222 illustrates receiving at least a portion of a specific instance of media from at least one remote user while at least one remote user is within range. For example, network connector 106 of mobile device 102 receiving at least a portion of a videogame while the user 1040 is within a certain range of at least one remote user 1041, . . . , and/or remote user 104N. More specifically, a wireless adaptor of a hand-held device receiving at least one packet indicative of a part of an action videogame from at least one buddy while the buddy is close to the user (e.g., within 5 meters, within the same building, and/or within the same network).

Example operation 1224 illustrates receiving at least a portion of a specific instance of media that is reduced in quality from at least one remote user. For example, network connector 106 of mobile device 102 receiving at least a portion of a specific instance of a videogame that is a different quality than the one at least one remote user 1041, . . . , and/or remote user 104N owns. More specifically, a wireless adaptor of a hand-held device receiving at least one packet indicative of a part of a version of an action game that is different quality than the one the buddy owns (e.g., transmitting low resolution instead of a high-definition version of a game/movie, and/or transmitting a game/movie at a low quality of service).

Example operation 1226 illustrates receiving at least a portion of a specific instance media that is operable for a limited amount of uses from at least one remote user. For example, network connector 106 of mobile device 102 receiving at least a portion of a specific instance of a videogame that can only be played a certain number of times from at least one remote user 1041, . . . , and/or remote user 104N. More specifically, a wireless adaptor of a hand-held device receiving at least one packet indicative of a part of an action game that can only be played a certain number of times from at least one buddy (e.g., user can only “die” in the game a certain number of times, user can start a game a certain number of times, user can join a game a certain number of times, and/or user can save their game a certain number of times).

Example operation 1228 illustrates receiving at least a portion of a coupon related to a specific instance of media from at least one remote user. For example, network connector 106 of mobile device 102 receiving a signal from at least one remote user 1041, . . . , and/or remote user 104N. The signal indicative of a token associated with a specific occurrence of media. More specifically, a wireless adaptor of a hand-held device receiving at least one packet indicative of a coupon that can be used to download a 30 second clip of a specific music video from a content provider.

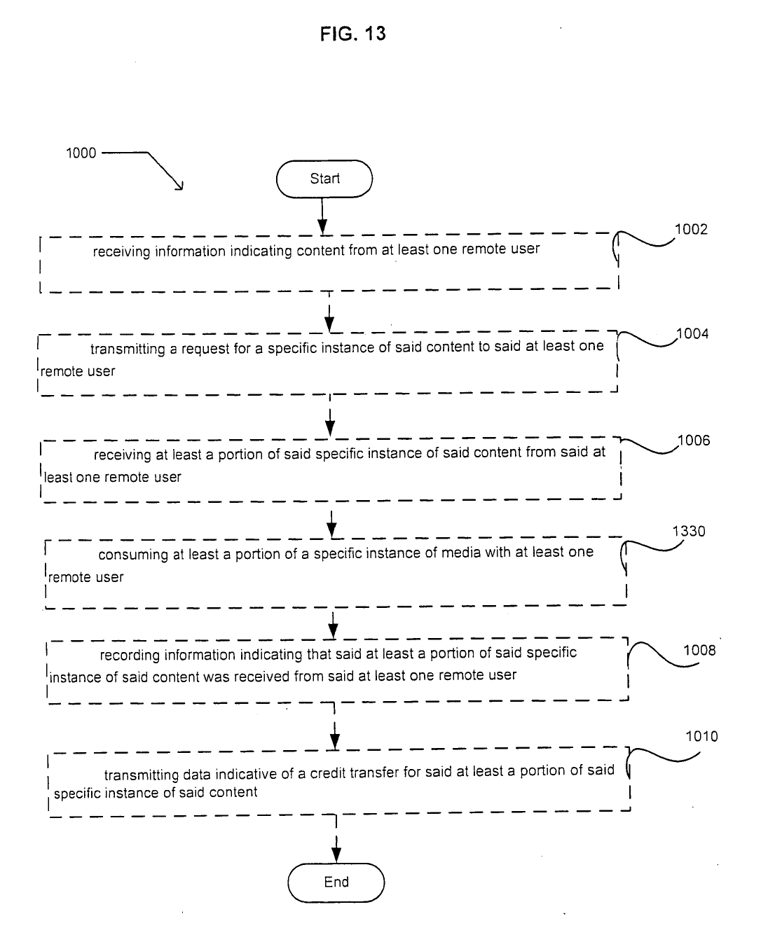

FIG. 13 illustrates an alternative embodiment of the example operational flow 1000 of FIG. 10 including the operation 1330.

Example operation 1330 depicts consuming at least a portion of a specific instance of media with at least one remote user. For example, user 1040 consuming (e.g., playing, watching, and/or listening) at least a portion of the transmitted media with at least one remote user 1041, . . . , and/or remote user 104N. A more specific example may be a person playing at least one level of a transmitted action game with at least one buddy.

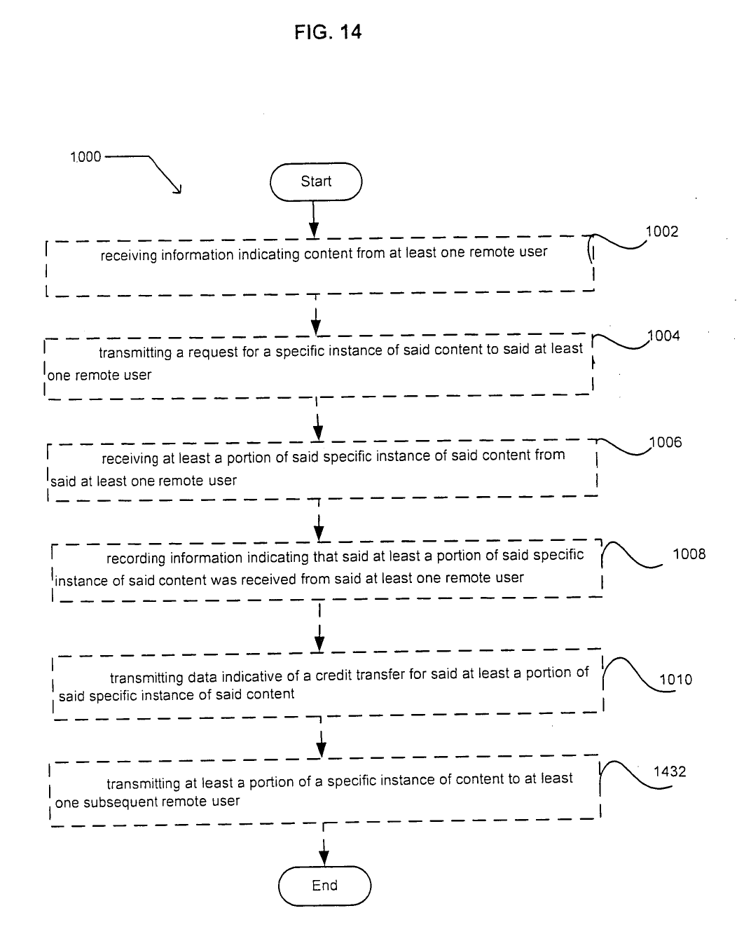

FIG. 14 illustrates an alternative embodiment of the example operational flow 1000 of FIG. 10 including the operation 1432.

Example operation 1432 illustrates transmitting at least a portion of a specific instance of said content to at least one subsequent remote user. For example, network connector 106 of mobile device 102 transmitting at least a part of specific content (e.g., movie, or coupon for a movie) received from at least one remote user 1041, and/or remote user 104N to at least one subsequent remote user 104S. For example, a user receiving a specific instance of content and transmitting that content to a subsequent buddy. A specific example may include a wireless adaptor of a hand-held device transmitting a packet indicative of a part of an occurrence of content (e.g., movie, song, or coupon related to a movie or song) to third person. The user may have received the full version of a movie from a buddy and may have the ability to transfer that full movie, a portion of the movie, a demo of the movie, or a coupon related to any specific occurrence of that movie to a subsequent buddy. A more specific example may include an Ethernet adaptor of a laptop computer transmitting a packet including a coupon for the full version of a movie to a third party.

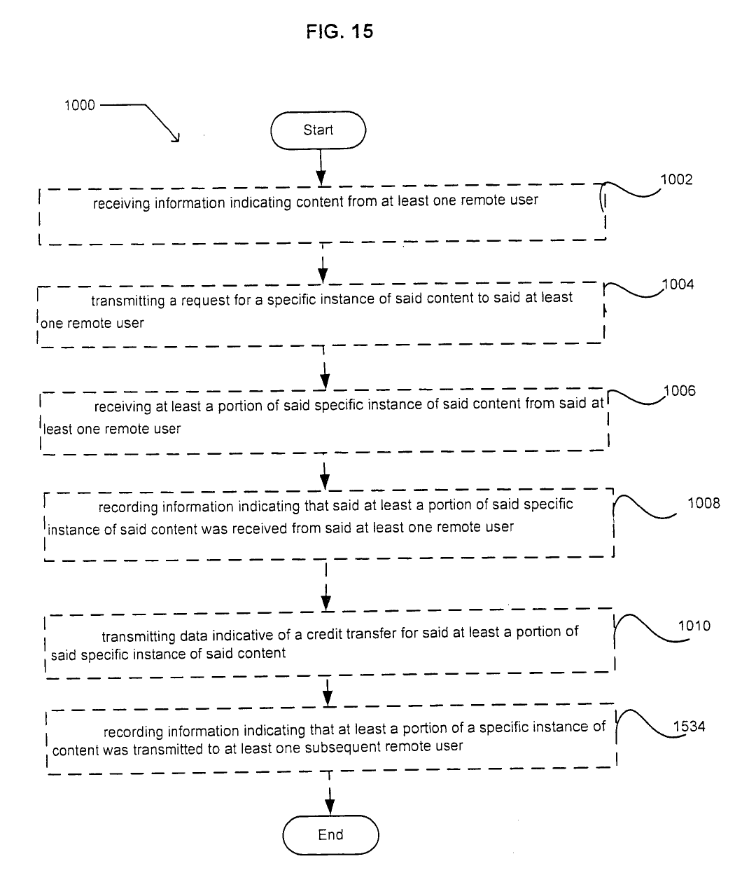

FIG. 15 illustrates an alternative embodiment of the example operational flow 1000 of FIG. 10 including the operation 1534.

Example operation 1534 shows recording information indicating that at least a portion of a specific instance of content was transmitted to at least one subsequent remote user. For example, control logic 112 of mobile device 102 storing information in a user account 116 associated with a user 1040. The information indicating that user 1040 transmitted at least a part of a specific occurrence of content received from at least one remote user 1041, . . . , and/or remote user 104N to at least one subsequent remote user 104S. More specifically, software of a hand-held device saving a record in a user account, the record containing information indicating that the user transmitted the movie received from a buddy to a subsequent buddy.

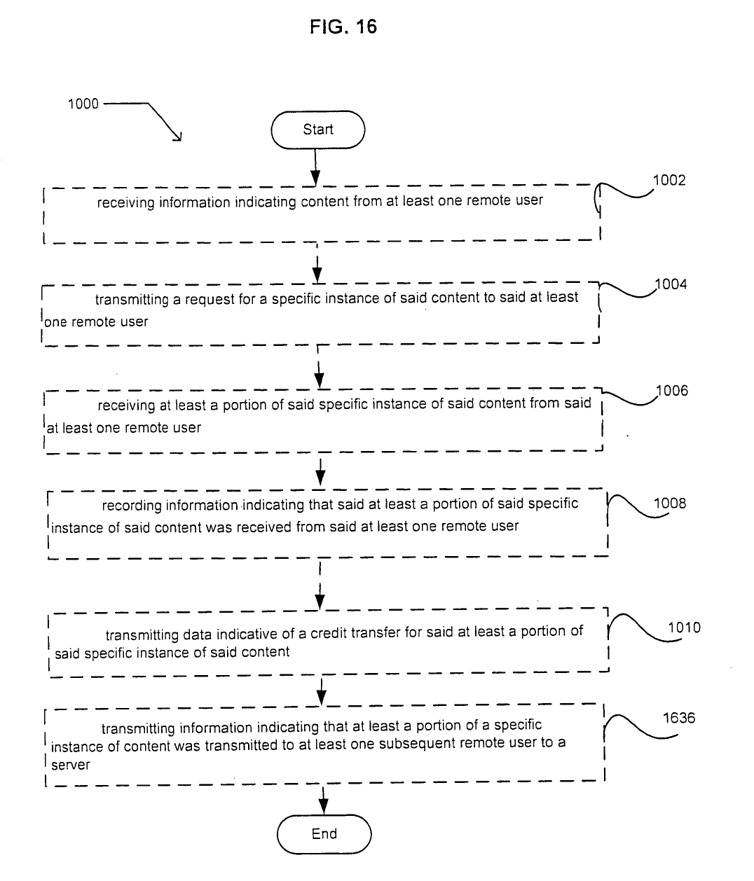

FIG. 16 illustrates an alternative embodiment of the example operational flow 1000 of FIG. 10 including the operation 1636.

Example operation 1636 depicts transmitting information indicating that at least a portion of specific instance of content was transmitted to at least one subsequent remote user to a server. For example, network connector 106 of mobile device 102 transmitting information to a server 114. The information indicating that a user 1040 transmitted at least a part of a specific occurrence of media and/or coupon associated with media, received from at least one remote user 1041, . . . , and/or remote user 104N to a subsequent remote user 104S. More specifically, a wireless adaptor of a hand-held device transmitting a packet to a content provider, the packet indicative of information related to the transmission of the documentary film received from a buddy to a subsequent buddy.

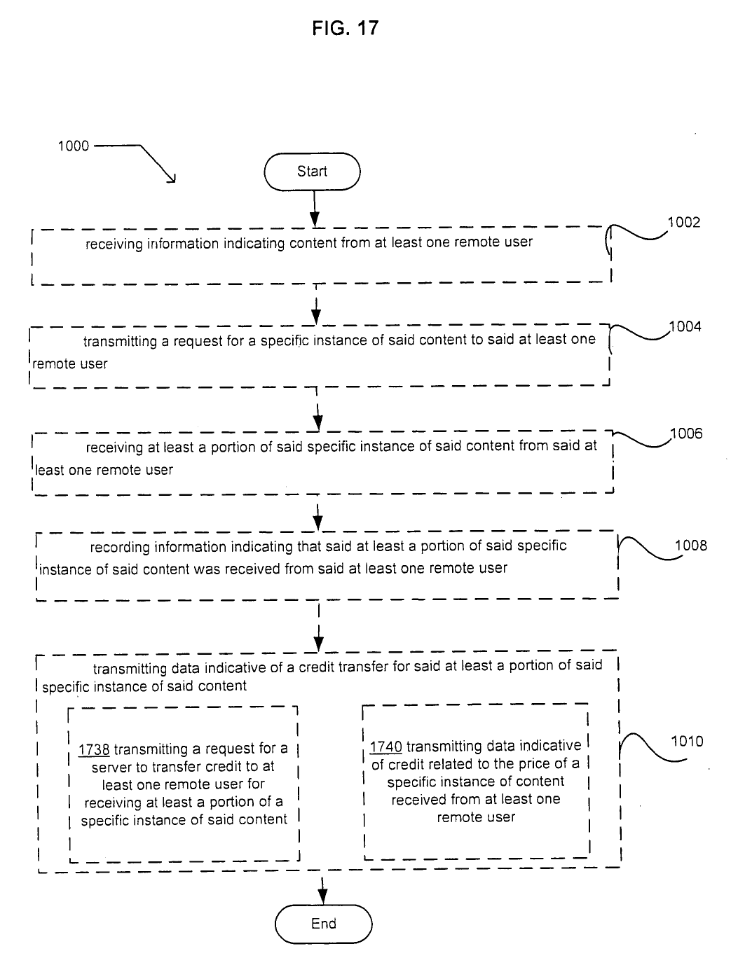

FIG. 17 illustrates an alternative embodiment of the example operational flow 1000 of FIG. 10. FIG. 17 shows operation 1010 transmitting data indicative of a credit transfer for said at least a portion of said specific instance of said content including the operations 1738 and 1740.

Example operation 1738 shows transmitting a request for a server to transfer credit to at least one remote user for receiving at least a portion of a specific instance of said content. For example, network connector 106 of mobile device 102 transmitting a signal to a server 114, the signal indicative of a credit transfer from a user account 116 associated with user 1040 to the user account 116 associated with at least one remote user 1041, . . . , and/or remote user 104N for the specific occurrence of content transferred. More specifically, a wireless adaptor of a hand-held device transmitting a packet to a content provider, the packet including a request to transfer credit from the user account to a buddy's account for the action movie transmitted to the user.

Example operation 1740 shows transmitting data indicative of credit related to the price of a specific instance of content received from at least one remote user. For example, network connector 106 of mobile device 102 transmitting a signal to a server 114, the signal including information indicating that a user account 16 associated with a user 1040 has been charged an amount related to the value of the specific occurrence of content transmitted by a remote user 1041, . . . , and/or remote user 104N. More specifically, a wireless adaptor of a hand-held device transmitting a packet, the packet including information indicating a user account has been charged an amount related to the value of the action movie received from a buddy.

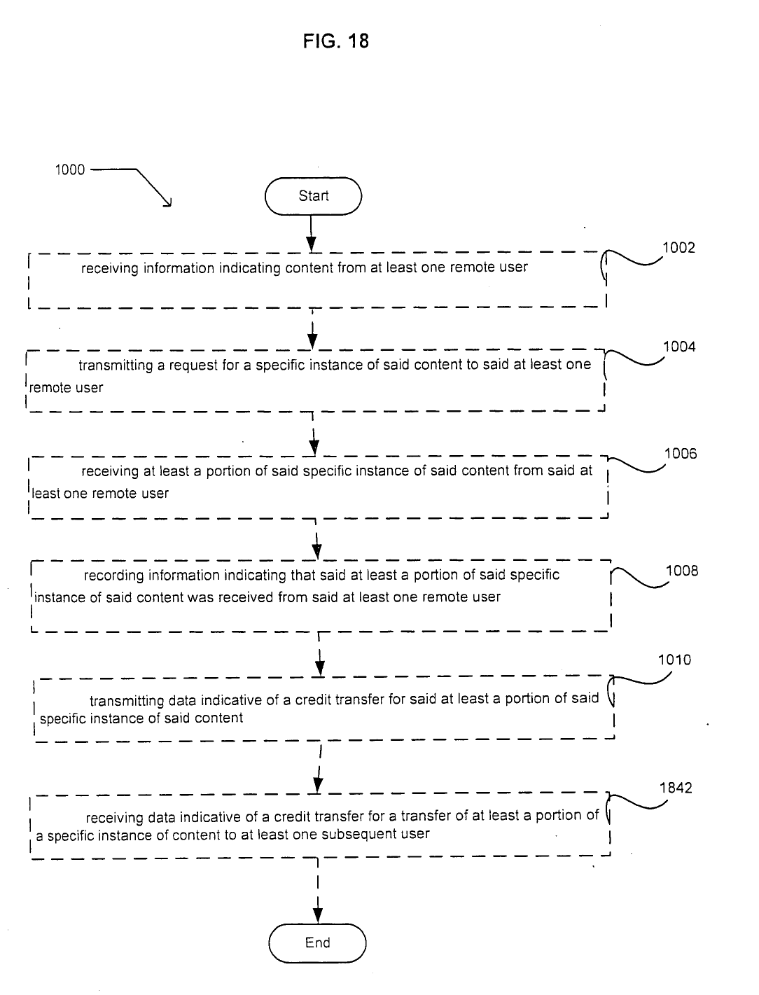

FIG. 18 illustrates an alternative embodiment of the example operational flow 1000 of FIG. 10 including the operation 1842.

Example operation 1842 shows receiving data indicative of a credit transfer for a transfer of at least a portion of a specific instance of content to at least one subsequent user. For example, network connector 106 of mobile device 102 receiving a signal indicating a credit transfer from at least one subsequent user 104S. The credit transfer is for a transfer of a specific occurrence of a movie from a user 1040 to at least one subsequent user 104S. More specifically, a wireless adaptor of a hand-held device receiving a packet, the packet including information related to a transfer of credit for a full version of an action movie.

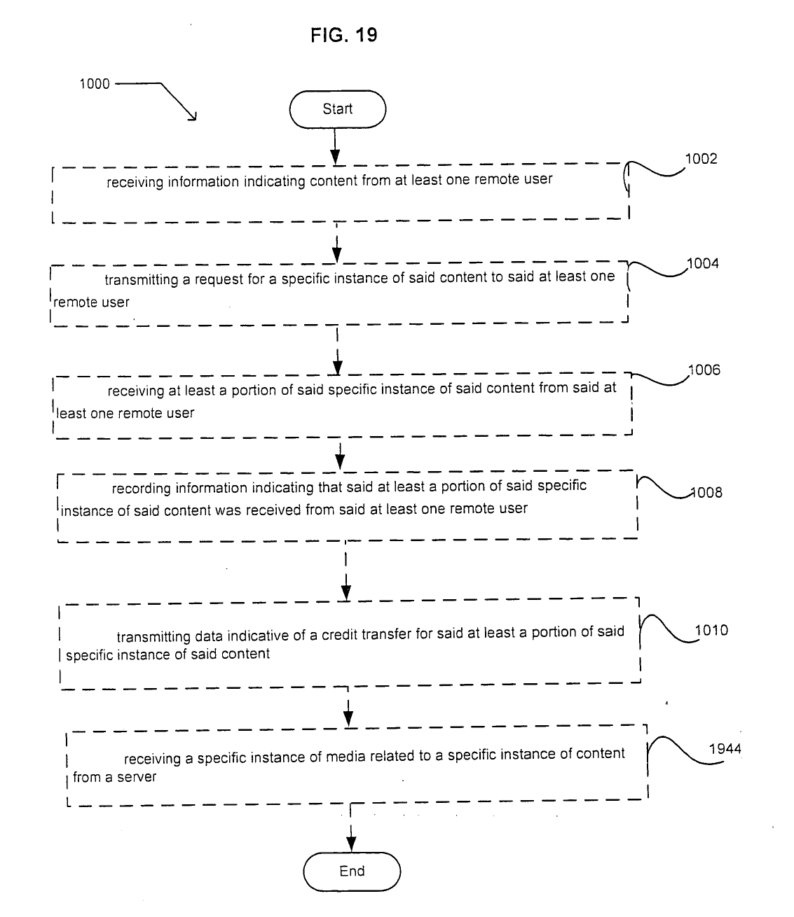

FIG. 19 illustrates an alternative embodiment of the example operational flow 1000 of FIG. 10 including the additional step 1944.

Example operation 1944 illustrates receiving a specific instance of media related to a specific instance of content from a server. For example, network connector 106 of mobile device 102 receiving a specific occurrence of media from a server 114. The specific occurrence of media may be associated with a token received from at least one remote user 1041, . . . , and/or remote user 104N. More specifically, a wireless adaptor of a hand-held device receiving a movie associated with a coupon from a server.

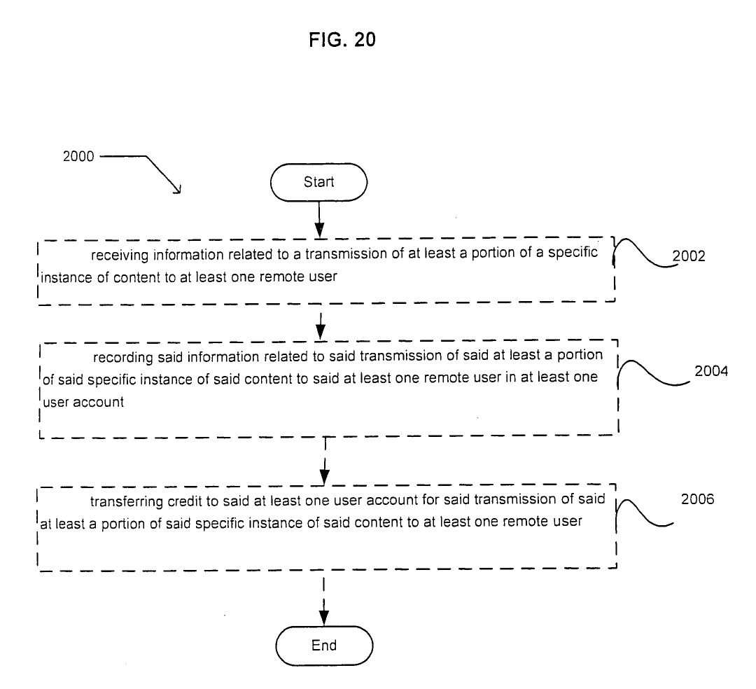

FIG. 20 illustrates the operational flow 2000 representing example operations related to peer to peer content distribution that optionally may include one or more of the operations 2002, 2004, and/or 2006.

Operation 2000 starts the operational flow. Operation 2002 depicts receiving information related to a transmission of at least a portion of a specific instance of content to at least one remote user. For example, network connector 106 of server 114 receiving a signal, the signal indicative of a transfer (e.g., a potential or an actual transfer) of a specific occurrence of content to at least one remote user 1041, . . . , and/or remote user 104N. More specifically, a content provider receiving over the internet at least one packet indicative of information indicating what type of content (e.g., coupon for a demo version of videogame, coupon to reduce the cost of a movie, or a song) a user wishes to transmit to at least one buddy.

Operation 2004 illustrates recording said information related to said transmission of said at least a portion of said specific instance of said content to said at least one remote user in at least one user account. For example, and in addition to the previous example, server control logic 122 of server 114 recording information in a user account 116 associated with a user 1040 and/or at least one remote user 1041, . . . , and/or remote user 104N. The user account(s) 116 may be maintained by a user account database 118. The information recorded may be indicative of a transfer of a specific occurrence of content to at least one remote user 1041, . . . , and/or remote user 104N. A specific example may include server control logic (e.g., hardware, software, firmware, or any combination thereof) of a content provider storing information received over the internet relating to the transmission of a demo version of a videogame in the account of the user who transferred the content and/or the account(s) of the one or more buddies who received the demo videogame.

Operation 2006 shows transferring credit to said at least one user account for said transmission of said at least a portion of said specific instance of said content to at least one remote user. For example, and in addition to the previous example, server control logic 112 of server 114 transmitting a signal indicative of a credit transfer to a user account 116 associated with a user 1040 maintained by a user account database 118. The server 114 transferring credit to the user 1040 for the transmission of a specific occurrence of content to at least one remote user 1041, . . . , and/or remote user 1104N. More specifically, software of a content provider web server transferring an amount of points (e.g., tokens that may be exchanged for value by a user, money, or any other type of value) to the user account of a user stored in a database because the user transferred a ring tone to a buddy.

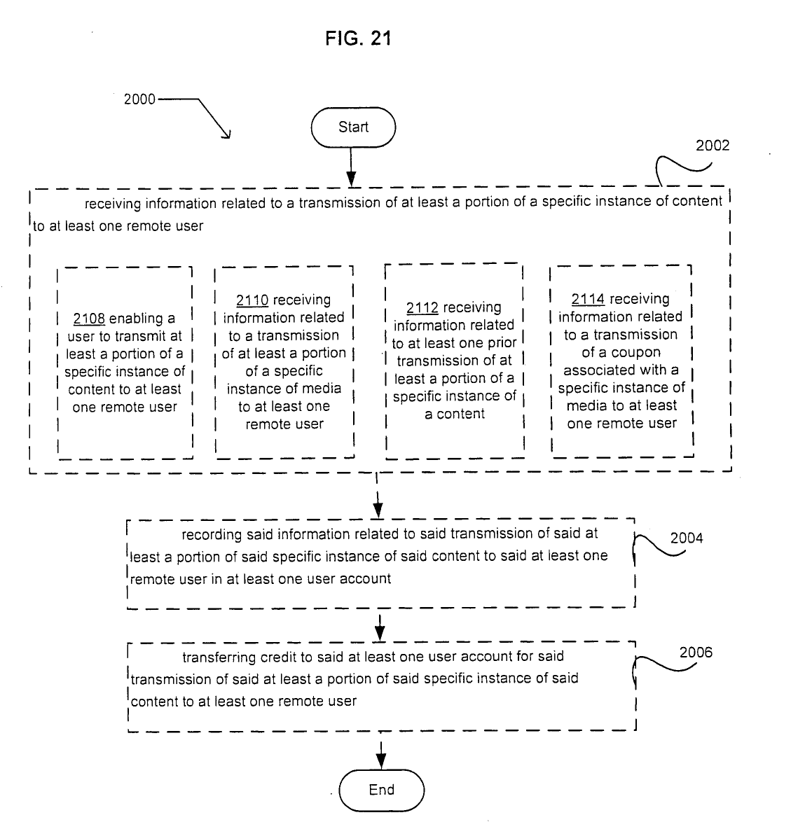

FIG. 21 illustrates an alternative embodiment of the operational flow 2000 of FIG. 20. FIG. 21 shows operation 2002 receiving information related to a transmission of at least a portion of a specific instance of content to at least one remote user including the operations 2108, 2110, 2112, and/or 2114.

Example operation 2108 illustrates enabling a user to transmit at least a portion of a specific instance of content to said at least one remote user. For example, the operation 2108 may include but is not limited to receiving a signal related to a potential transmission of a specific occurrence of content and subsequently, or almost simultaneously enabling the user 1040 to transfer the specific occurrence of content to at least one remote user 1040, . . . , and/or remote user 104N. The server 114 may enable the transfer of content by, for example, sending an authorization signal to a user 1040 or sending the one or more remote users 1041, . . . , and/or remote user 104N a “key” or “code” that may be entered into the mobile device 102 that enables the content. A specific example may include transmitting a packet that authorizes a user to transfer a movie to a remote user.

Example operation 210 illustrates receiving information related to a transmission of at least a portion of a specific instance of media to said at least one remote user. For example, network connector 106 of server 114 receiving a signal, the signal indicative of a potential or an actual transfer of a specific occurrence of media (e.g., specific version of a song, movie, or videogame) to at least one remote user 1041, . . . , and/or remote user 104N. More specifically, a content provider receiving over the internet at least one packet indicative of information indicating what movie a user wishes to transfer to at least one buddy.

Example operation 2112 illustrates receiving information related to at least one prior transmission of at least a portion of a specific instance of a content. For example, network connector 106 of server 114 receiving data including information indicating the identity of any prior remote user 104P (optionally) connected to a prior network 190P) that transmitted the specific occurrence of content to a user 1040 before the user 1040 transfers the content to a remote user 1041, . . . , and/or remote user 104N. More specifically, a content provider receiving over the internet a packet related to the transfer of a full version of a videogame, the information including the identity of any prior user who had previously transmitted the full version of an action videogame to the user.

Example 2114 illustrates receiving information related to a transmission of a coupon associated with a specific instance of media to at least one remote user. For example, network connector 106 of server 114 receiving a signal indicative of a potential or an actual transfer of a specific instance of a coupon (e.g., coupon for specific version of a song, movie, or videogame) to at least one remote user 1041, . . . , and/or remote user 104N. More specifically, a content provider receiving over the internet at least one packet indicative of information indicating that a coupon related to a specific movie was transmitted to at least one buddy.

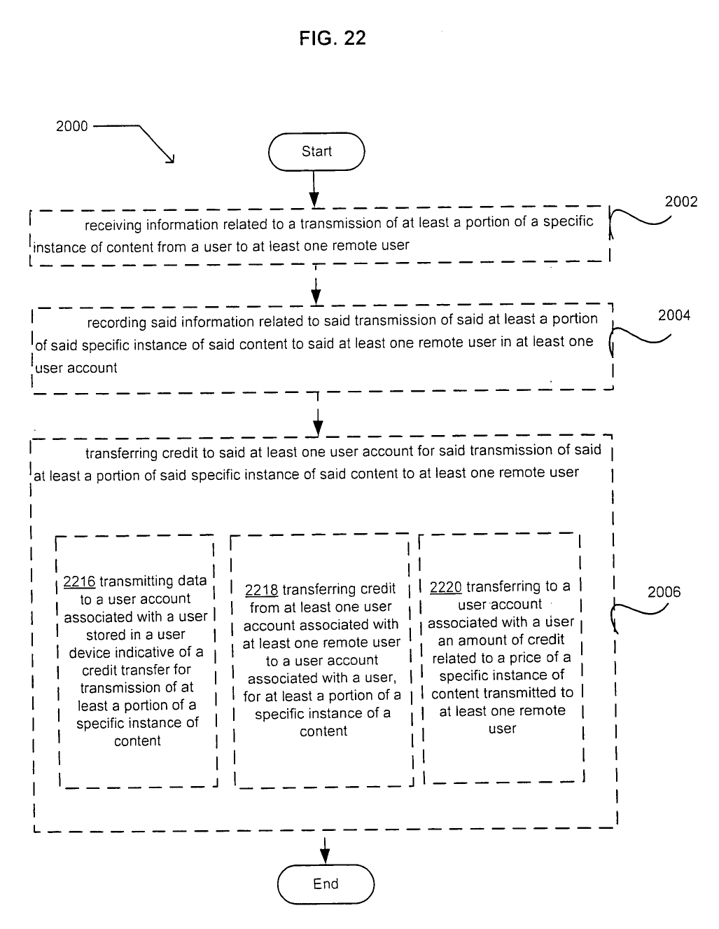

FIG. 22 illustrates an alternative embodiment of the operational flow 2000 of FIG. 20. FIG. 22 shows the operation 2006 transferring credit to said at least one user account for said transmission of said at least a portion of said specific instance of said content to at least one remote user including the operations 2216, 2218, and/or 2220.

Example operation 2216 shows transmitting data to a user account associated with a user stored in a user device indicative of a credit transfer for transmission of at least a portion of a specific instance of said content. For example, crediting a user account may include but is not limited to a server 114 with network connector 106 transmitting data to a user 1040. The data may indicate that credit was added to the user account 116 associated with user 1040. More specifically, a content provider transmitting a packet indicative of payment to a user account stored in a user's laptop computer.

Example operation 2218 illustrates transferring credit from at least one user account associated with at least one remote user to a user account associated with a user for at least a portion of a specific instance of content. For example, crediting a user account may include but is not limited to server control logic 122 transferring credit to a user account 116 associated with a user 1040 stored in a user account database 118. The credit may be transferred from the user account 116 associated with at least one remote user 1041, . . . , and/or remote user 104N account stored in a user account database 118. The transfer of credit may be for the specific occurrence of content received by at least one remote user 1041, . . . , and/or remote user 104N from a user 1040.

Example operation 2220 shows transferring to a user account associated with a user an amount of credit related to a price of a specific instance of content transmitted to at least one remote user. For example, server control logic 122 of server 114 transferring credit to a user account 116 associated with a user 1040 stored in a user account database 118. The amount of credit transferred may be proportional to the Value of the specific occurrence of content transferred to at least one remote user 1041, . . . , and/or remote user 104N. The credit may be transferred from one or more server accounts 180 or any user account 116 associated with at least one remote user 1041, . . . , and/or remote user 104N who received the specific occurrence of content. More specifically, software of a server running a routine to transfer an amount of money to the account of a user from an account associated with the content provider. The amount of money transferred may be dependent on the version of content transferred to a buddy, e.g., a user may receive more money for the transfer of an entire movie than for the transfer of a coupon redeemable for the demo version of the same movie.

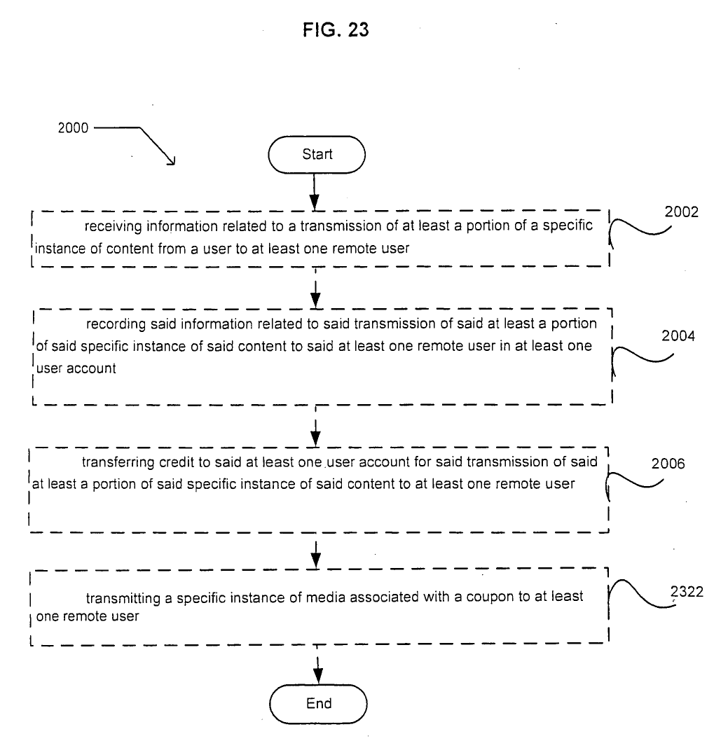

FIG. 23 shows an alternative embodiment of the operational flow of 2000 of FIG. 20 including the operation 2322.

Example operation 2322 shows transmitting a specific instance of media associated with a coupon to at least one remote user. For example, network connector 106 of server 114 transmitting a specific occurrence of media (e.g., music, video, and/or pictures) from content storage 120. The media transmitted may be related to a coupon received from a user 1040 to at least one remote user 1041, . . . , and/or remote user 104N. More specifically, an Ethernet port of a content provider transmitting a packet from a videogame database in response to the reception of a packet indicative of a coupon for the demo version of a videogame, the packet transmitted by the content provider containing the demo version of a videogame.

FIG. 94 shows an alternative embodiment of the operational flow of 2000 of FIG. 20 including the operation 2424.

Example operation 2424 illustrates transferring credit to a user account associated with a prior user, said prior user previously transmitting a specific instance of content to a user. For example, server control logic 112 of server 114 transmitting a signal indicative of a credit transfer to the user account 16 associated with a prior user 104P maintained by a user account database 118. The server 14 crediting the user account 116 of a prior user 104P for their transfer of the specific occurrence of content to a user 1040 and the user's 1040 subsequent transmission to at least one remote user 1041, . . . , and/or remote user 104N. More specifically, software of a content provider transferring an amount of credit to the account of a previous user of a specific movie after a user subsequently transmitted the specific movie to a buddy.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or, drawings, should be understood to contemplate the possibilities of including one of the terms, either of the terms, or both terms. For example, the phrase “A or B” will be understood to include the possibilities of “A” or “B” or “A and B”.

1.-18. (canceled)

19.-36. (canceled)

37.-54. (canceled)

55.-72. (canceled)

73. A method of distributing content comprising:
receiving information related to a transmission of at least a portion of a specific instance of content to at least one remote user;
recording said information related to said transmission of said at least a portion of said specific instance of said content to said at least one remote user in at least one user account; and
transferring credit to said at least one user account for said transmission of said at least a portion of said specific instance of said content to at least one remote user.

74. The method of claim 73 wherein said receiving information related to a transmission of at least a portion of a specific instance of content to at least one remote user further comprises:
enabling a user to transmit at least a portion of a specific instance of content to said at least one remote user.

75. The method of claim 73 wherein said receiving information related to a transmission of at least a portion of a specific instance of content to at least one remote user comprises:
receiving information related to a transmission of at least a portion of a specific instance of media to said at least one remote user.

76. The method of claim 73 wherein said receiving information related to a transmission of at least a portion of a specific instance of content to at least one remote user comprises:
receiving information related to at least one prior transmission of at least a portion of a specific instance of a content.

77. The method of claim 73 wherein said receiving information related to a transmission of at least a portion of a specific instance of content to at least one remote user comprises:
receiving information related to a transmission of a coupon associated with a specific instance of media to at least one remote user.

78. The method of claim 73 wherein said transferring credit to said at least one user account for said transmission of said at least a portion of said specific instance of said content to at least one remote user further comprises:
transmitting data to a user account associated with a user stored in a user device indicative of a credit transfer for transmission of at least a portion of a specific instance of said content.

79. The method of claim 73 wherein said transferring credit to said at least one user account for said transmission of said at least a portion of said specific instance of said content to at least one remote user further comprises:
transferring credit from at least one user account associated with at least one remote user to a user account associated with a user for at least a portion of a specific instance of content.

80. The method of claim 73 wherein said transferring credit to said at least one user account for said transmission of said at least a portion of said specific instance of said content to at least one remote user comprises:
transferring to a user account associated with a user an amount of credit related to a price of a specific instance of content transmitted to at least one remote user.

81. The method of claim 73 further comprising:
transmitting a specific instance of media associated with a coupon to at least one remote user.

82. The method of 73 further comprising:
transferring credit to a user account associated with a prior user, said prior user previously transmitting a specific instance of content to a user.

83. A system for distributing content comprising
circuitry for receiving information related to a transmission of at least a portion of a specific instance of content to at least one remote user;
circuitry for recording said information related to said transmission of said at least a portion of said specific instance of said content to said at least one remote user in at least one user account; and
circuitry for transferring credit to said at least one user account for said transmission of said at least a portion of said specific instance of said content to at least one remote user.

84. The system of claim 83 wherein said circuitry for receiving information related to a transmission of at least a portion of a specific instance of content to at least one remote user comprises:
circuitry for enabling a user to transmit at least a portion of a specific instance of content to said at least one remote user.

85. The system of claim 83 wherein said circuitry for receiving information related to a transmission of at least a portion of a specific instance of content to at least one remote user comprises:
circuitry for receiving information related to a transmission of at least a portion of a specific instance of media to said at least one remote user.

86. The system of claim 83 wherein said circuitry for receiving information related to a transmission of at least a portion of a specific instance of content to at least one remote user comprises:
circuitry for receiving information related to at least one prior transmission of at least a portion of a specific instance of a content.

87. The system of claim 83 wherein said circuitry for receiving information related to a transmission of at least a portion of a specific instance of content to at least one remote user comprises:
circuitry for receiving information related to a transmission of a coupon associated with a specific instance of media to at least one remote user.

88. The system of claim 83 wherein said circuitry for transferring credit to said at least one user account for said transmission of said at least a portion of said specific instance of said content to at least one remote user comprises:
circuitry for transmitting data to a user account associated with a user stored in a user device indicative of a credit transfer for transmission of at least a portion of a specific instance of said content.

89. The system of claim 83 wherein said circuitry for transferring credit to said at least one user account for said transmission of said at least a portion of said specific instance of said content to at least one remote user comprises:
circuitry for transferring credit from at least one user account associated with at least one remote user to a user account associated with a user for at least a portion of a specific instance of content.

90. The system of claim 83 wherein said circuitry for transferring credit to said at least one user account for said transmission of said at least a portion of said specific instance of said content to at least one remote user comprises:
circuitry for transferring to a user account associated with a user an amount of credit related to a price of a specific instance of content transmitted to at least one remote user.

91. The system of claim 83 further comprising:
circuitry for transmitting a specific instance of media associated with a coupon to at least one remote user.

92. The system of claim 83 further comprising:
circuitry for transferring credit to a user account associated with a prior user, said prior user previously transmitting a specific instance of content to a user.

93.-104. (canceled)

105. (canceled)

106. (canceled)

107.-117. (canceled)

118. (canceled)

119. (canceled)

120. A system for receiving content comprising:
means for receiving information related to a transmission of at least a portion of a specific instance of content to at least one remote user;
means for recording said information related to said transmission of said at least a portion of said specific instance of said content to said at least one remote user in at least one user account; and
means for transferring credit to said at least one user account for said transmission of said at least a portion of said specific instance of said content to at least one remote user.
